(19) United States
(12) Patent Application Publication
(10) Pub. No.: US 2003/0124886 A1
(43) Pub. Date: Jul. 3, 2003

(54) Electrical contact with compliant section

(76) Inventors: Paul Reisdorf, Moorpar, CA (US); Ho P. Tran, Simi Valley, CA (US); Alla Shchur, Westlake Village, CA (US)

Correspondence Address: KANESAKA & TAKEUCHI, 1423 Powhatan Street, Alexandria, VA, 22314, US

(21) Appl. No.: 10/026,765

(22) Filed: Dec. 27, 2001

(51) Int. Cl. H01R 12/00

(52) U.S. Cl. 439/82

(57) ABSTRACT

An electrical contact comprises a compliant section (1) with a plurality of spring members (2), a U-shaped retention section (5) with a pair of arms (6) having sharp barbs (7), and a tubular section (8) with a pair of flexible beams (9) and a C-shaped rigid beam (10) with a stop tab (11).

### BACKGROUND OF THE INVENTION

1. Field of the Invention

The present invention relates to socket or pin type contacts with compliant section termination for use on printed circuit boards and electrical interconnections requiring such termination.

2. Description of the Related Art

Multitude of contact sockets and compliant press fit sections available address the electrical and mechanical functions of interconnection with corresponding pin and plated through hole using different fabrication and assembly methods. Socket sections often use only opposing beams or only “C” shaped configurations, each vulnerable to potential damage. These separate configurations also result in high or difficult to control insertion forces when mated with corresponding pin contacts. Metal deformation or compression, separate pieces for different functions, attachments of various pieces using welding or metal stamping techniques are utilized. All of them result in complex assembly techniques and very precise dimensional requirement. In addition, several separate pieces are assembled to produce combinations of socket sections with the compliant sections, jeopardizing reliability and adding to the cost.

### SUMMARY OF THE INVENTION

Accordingly, it is an object of the invention to provide a socket or pin type contact with a compliant section, without above listed problems, as a single metal unit, thus avoiding cost and risk of additional assembly and assuring uninterrupted electrical continuity. In addition, the single piece has also built-in retention and stop features when inserted in the corresponding insulator body.

According to the invention, the socket section of an electrical contact having a pair of independently flexible beams and a rigid beam opposed to the flexible beams so that the flexible beams are protected from potential damage. Even when one of them is damaged, the other assures electrical contact, thus providing reliability. The flexible and rigid beams and compliant section are formed from one metallic piece as a unit so that it is easy to produce an electrically reliable contact at low manufacturing cost.

### BRIEF DESCRIPTION OF THE DRAWINGS

FIG. 1 is a perspective view of a socket type contact with a compliant section according to an embodiment of the invention;

FIG. 2 is a partially cutaway, perspective view of the compliant section and plated through-hole in the printed circuit board;

FIGS. 3A and 3B are partially cutaway, perspective views of the compliant sections; and

FIG. 4 is a perspective view of a pin type contact with a compliant section according to another embodiment of the invention.

### DESCRIPTION OF THE PREFERRED EMBODIMENTS

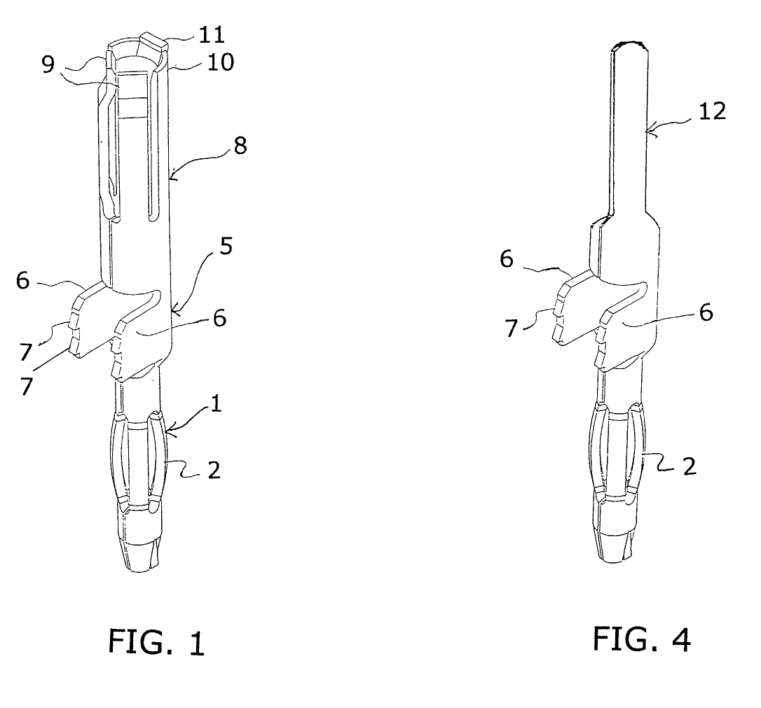

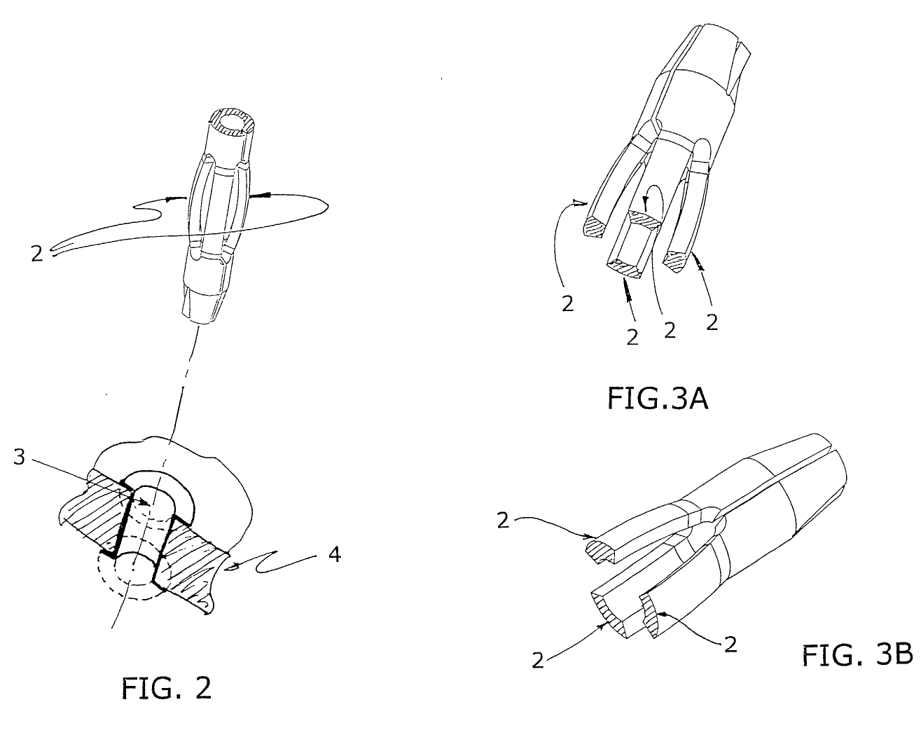

In FIGS. 1-3, the socket type contact is made of a single piece of formed metal. It comprises a compliant section 1 with a plurality of spring members 2 formed outward. The spring members 2 gradually deflect inward as they are being pushed into a plated through hole 3 of a printed circuit board 4. The retaining forces which push outward against the walls of the plated through hole 3 provides gas tight joint. As best shown in FIG. 3, the spring members 2 are formed spherically on all areas in contact with the intended surfaces of the plated through holes 3.

A “U” shaped retention section 5 extends upward from the compliant section 1. It has a pair of arms 6 each having a plurality of sharp barbs 7, providing interference with a corresponding cavity in the insulator body (not shown). The two arms 6 provide also a straight surface for the push-in into the corresponding insulator body and act as a stop, thus limiting the distance that the contact can be pushed into it.

A tubular section 8 extends upward from the retention section 5. It consists of three portions; two independently deflecting beams 9 located at angle to each other and a “C” configured rigid opposing section 10. The two deflecting beams 9 may be of the same or different lengths or widths. Also, they may be tapered toward the entry side. They provide independent force against the inserted contact pin, which in turn is pushed against the rigid “C” configured section 10. This assures multiplicity of electrical contact points assuring continuity and reliability of electrical connection even when one of the two deflecting beams is damaged or bent. The “C” shaped configuration has an extend tab 11, which acts as a stop against the insulator. The “C” shaped configuration also provides guidance and self alignment to the entering corresponding mating pin contact, thus minimizing the possibility of damage to the opposing two deflecting beams 9. Also, it provides stability and control during manufacturing of the entire part. The extended tab 11 also acts as the first electrical discharged point when electrically charged applicable pin is being inserted into this contact.

Alternatively, the tubular section 8 may be replaced by a pin-shaped section 12 to form a pin type electrical contact as shown in FIG. 4. The other parts of the pin type contact are identical with those of the socket type contact and, therefore, their description will be omitted.

1. An electrical contact with a compliant section, comprising:
a compliant section having a plurality of spring members formed outward so as to gradually deflect inward as they are being pushed into a hole;
a retention section extending from said compliant section so as to provide interference with a cavity; and
a socket or pin section extending from said retention section so as to engage with a mating pin or socket for providing electrical and mechanical connection.

2. The electrical contact according to claim 1, wherein said socket section consists a pair of independently flexible beams and a rigid beam opposed to said deflecting beams.

3. The electrical contact according to claim 2, wherein said rigid beam has a C-shaped configuration.

4. The electrical contact according to claim 2, wherein said flexible beams are provided at angle to each other.

5. The electrical contact according to claim 2, wherein said flexible beams are of the same or different lengths or widths.

6. The electrical contact according to claim 2, wherein said flexible beams are tapered toward an entry side.

7. The electrical contact according to claim 2, which further comprises a stop tab extending from said rigid beam so as to act as not only a stop but also a first electrical discharge point.

8. The electrical contact according to claim 1, wherein said retention section has a pair of arms with at least one sharp barb for engagement with a wall of said cavity.
